(19) United States
(12) Patent Application Publication
(10) Pub. No.: US 2014/0181149 A1
(43) Pub. Date: Jun. 26, 2014

(54) SYSTEMS AND METHODS FOR PROVIDING MULTIMEDIA

(71) Applicant: Time Flash LLC, New City, NY (US)

(72) Inventors: Yoav Ilan, New York, NY (US); Jared A. Kash, New City, NY (US)

(73) Assignee: Time Flash LLC, New City, NY (US)

(21) Appl. No.: 14/028,402

(22) Filed: Sep. 16, 2013

Related U.S. Application Data
(60) Provisional application No. 61/701,549, filed on Sep. 14, 2012.
(60) Provisional application No. 61/799,030, filed on Mar. 15, 2013.

(51) Int. Cl. G06F 17/30

(52) U.S. Cl. CPC G06F 17/30058
USPC 707/784

(57) ABSTRACT

Exemplary embodiments of methods and systems for providing multimedia are provided. A method for providing multimedia can include receiving one or more data files containing multimedia from a first user, storing the one or more data files containing the multimedia, and providing at least one of the one or more data files based on access granted by the first user and at a future time set by the first user. A trustee service can be provided to provide the one or more data files to a user at a future time based on predetermined criteria, such as a data, condition or future event.

### CROSS-REFERENCE TO RELATED APPLICATIONS

This application relates to and claims priority from U.S. Patent Application Ser. No. 61/701,549 filed Sep. 14, 2012, and U.S. Patent Application Ser. No. 61/799,030 filed Mar. 15, 2013, the entire disclosures of which are hereby incorporated herein by reference.

### FIELD OF THE DISCLOSURE

The present disclosure relates to exemplary embodiments of methods and systems for providing multimedia, and more particularly, to exemplary embodiments of methods and systems for providing multimedia from a sender to a recipient at a future time.

### BACKGROUND INFORMATION

People throughout history have tried to save some type of artifacts about themselves, their family or someone they know. A problem with artifacts is that they can get lost or destroyed over time. Further, the preservation of such artifacts can be resource intensive and expensive. Due to the high costs of creating and managing such artifacts, most individuals do not save such artifacts. Currently, the artifacts of an individual's life can be kept in boxes, on shelves, and in storage facilities. Most people do not have the personal wealth necessary to preserve the personal artifacts of each family member's life.

Physical artifacts cannot be shared in multiple locations at one time. The transfer of artifacts into the future usually fragments the original collection because recipients lack the resources and space to keep all of the items together. It's easier for a family to divide up the possessions, e.g., books, painting, dishes, jewelry, cookware, house, car, pictures, letters, etc., of a loved one after death than for a single descendent to take responsibility for the preservation of these life artifacts. Often these items are sold to others who have the resources and inclination to own these possessions. Furthermore, physical items cannot be copied without devaluing the original item, because the value of physical items is based on scarcity. Therefore, the items must be shared such that the ability to share these artifacts is limited by the resources of the recipient of these items.

Digital technology and social media tools for capturing, curating, publishing, and syndicating media can provide for new opportunities to tell the story of humanity. However, the current methods lack the necessary controls to make today's story viewable and useable by future generations of our family, community, and civilization. Today's social networks only capture the moments that people choose to share with the public. They may not capture all the significant moments in a person's life and weave those moments into a collective story of a generation or a larger moment in time.

Social media networks are focused on and designed for communicating in the present and on real-time communications, not the future. The architecture of these communications omits the ability to archive the important moments worth remembering. The digital world has the ability to provide a new type of sharing of life information. When you look at a person in real time, all you can see is their life in the moment. When people post information (e.g., writings, pictures, videos, & recordings) of themselves online, they are leaving behind a digital footprint, or digital identity. Right now it is difficult to save that information in one easily accessible place to share with an audience in the future with specific controls in place deeming who gets to see it and when.

Digital media cannot be easily aggregated across platforms over time. Digital media, e.g., photos, text, videos and other multimedia, from disparate social networks cannot be easily aggregated in a readily accessible form and therefore it is difficult to knit together the story of a person's life. Collecting all the digital artifacts that users want to save requires open, cross-platform technologies that plug-in to social networks, where many of these digital artifacts are generated.

Further, people may wish to provide messages to others such as future generations, but leaving a letter or some other communication not knowing whether that person will ever receive that communication, or whether an event that would trigger that communication will happen, is often problematic for people that wish to provide such messages. For example, a father of children may wish to send a video message to his first future grandchild that will arrive on the future grandchild's seventh birthday. A mother of a six year old daughter may wish to send a video greeting for her daughter's sixteenth birthday, who may not have an email account yet. A grandfather for a grownup single young woman may wish to send a message to his granddaughter's future husband, and since the granddaughter is not in a relationship at the moment the future husband is not defined and thus not addressable. A woman may want to send an empowering video message to all of her future female offspring in future generations to come, which is triggered by an event such as an inauguration of the first U.S. female president. However, in all these examples, the people or the date of the event may not be known, and may need to be triggered by an event or by a person's birth or marriage or so forth.

Therefore, there is a need for methods and systems for providing multimedia relating to an individual's life to specific recipients chosen by the individual, in which such multimedia can be provided at a time determined by the individual.

### SUMMARY OF EXEMPLARY EMBODIMENTS OF THE DISCLOSURE

At least some of the above described problems can be addressed by exemplary embodiments of the methods and systems according to the present disclosure. For example, using such exemplary embodiments, it is possible to provide methods and systems that provide for people to capture memories for posterity, e.g., moments that matter most personally and in the context of history, to be kept private and enjoyed later in life, or shared with family members in the future, or added to the story of humanity. The exemplary embodiments of the methods and systems provide for capturing, publishing, and delivering memories based on permissions, events, and time. Advancement of data, mobile computing and other technologies can allow people to digitally capture and archive their life's most memorable moments, create digital messages for specific audiences in future generations, and record stories that can survive using the methods and systems of the present disclosure.

The present disclosure describes exemplary embodiments of methods and systems that can provide for a service that can allow for electronic messages of various types (e.g., text, images, videos and/or audio) to future recipients who may not exist, may not be addressable, may not be defined at the time of creating the message, or may be based on certain events. The delivery can be triggered by logical conditions that may occur at any point in the future.

For example, using such exemplary embodiments, it is possible to provide a method for providing multimedia, comprising receiving one or more data files containing multimedia from a first user, storing the one or more data files containing the multimedia, and providing at least one of the one or more data files based on access granted by the first user and at a future time set by the first user. The multimedia can comprise one or more of image(s), audio, text, animation and video. The first user and at least one other user can provide multimedia to at least one of the one or more data files.

The method can further comprise providing the at least one of the one or more data files to one or more users, and providing notification to the one or more users that the at least one of the one or more data files shall be provided by the first user before providing the at least one of the one or more data files to the one or more users. The at least one of the one or more data files are provided in a chronological order. The one or more data files can be received from an electronic device including one or more of a mobile device, laptop, notepad, tablet or personal computer.

In some exemplary embodiments, a computer-accessible medium can be provided which contains thereon software for providing multimedia, wherein, when a processing arrangement executes the software, the processing arrangement is configured to perform procedures comprising receiving one or more data files containing multimedia from a first user, storing the one or more data files containing the multimedia, and providing at least one of the one or more data files based on access granted by the first user and at a future time set by the first user. The multimedia can comprise one or more of image(s), audio, text, animation and video.

The processing arrangement can be further configured to perform procedures comprising providing the at least one of the one or more data files to one or more users, and providing notification to the one or more users that the at least one of the one or more data files shall be provided by the first user before providing the at least one of the one or more data files to the one or more users.

In some exemplary embodiments, a system for providing multimedia can be provided, comprising a database of accounts for each of a plurality of users, a storage system for storing data files containing multimedia associated with the accounts for each of the plurality of users, including first instructions from each of the plurality of users specifying a set of user(s) that the data files associated with their respective accounts can be provided to, and second instructions specifying when the set of user(s) can be provided the data files associated with their respective accounts, and a processing arrangement configured to provide the data files to the specified set of user(s) based on the first and second instructions.

The processing arrangement can be further configured to provide notification to the specified set of user(s) that the data files shall be provided before providing the data files to the specified set of user(s) based on the first and second instructions. The multimedia can comprise one or more of image(s), audio, text, animation and video. Each data file can contain multimedia from more than one of the plurality of users. The data files can be provided in a chronological order. The one or more data files containing multimedia can be received from each of the plurality of users from an electronic device including one or more of a mobile device, laptop, notepad, tablet or personal computer.

In some exemplary embodiments, a method of providing a trustee service for providing multimedia can be provided, comprising receiving one or more data files containing multimedia from a first user, storing the one or more data files containing the multimedia, receiving information from the first user specifying one or more people with whom at least one of the one or more data files should be provided to based on a predetermined criteria, monitoring if the predetermined criteria has been met over a period of time, and providing the at least one of the one or more data files to the one or more people specified by the first user when the predetermined criteria has been met. The multimedia can comprise one or more of image(s), audio, text, animation and video.

The predetermined criteria can comprise one or more of a date, a condition and a future event. The method can further comprise providing notification to the one or more people specified by the first user that the at least one of the one or more data files shall be provided by the first user before providing the at least one of the one or more data files to the one or more people specified by the first user. The at least one of the one or more data files can be provided electronically to the one or more people specified by the first user.

These and other objects, features and advantages of the present disclosure will become apparent upon reading the following detailed description of embodiments of the present disclosure, when taken in conjunction with the appended claims.

### BRIEF DESCRIPTION OF THE DRAWINGS

The foregoing and other exemplary objects of the present disclosure will be apparent upon consideration of the following detailed description, taken in conjunction with the accompanying exemplary drawings and claims, in which like reference characters refer to like parts throughout, and in which:

FIG. 1 is an illustration of a system according to an exemplary embodiment of the present disclosure;

FIGS. 2-7 are illustrations of a mobile application according to an exemplary embodiment of the present disclosure;

FIG. 8 is a block diagram of a trustee service according to an exemplary embodiment of the present disclosure; and

FIG. 9 is an illustration of an example in which the trustee service of FIG. 8 can be utilized according to an exemplary embodiment of the present disclosure.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative embodiments. It is intended that changes and modifications can be made to the described embodiments without departing from the true scope and spirit of the subject disclosure.

### DETAILED DESCRIPTION OF EXEMPLARY EMBODIMENTS OF DISCLOSURE

Exemplary embodiments of the methods and systems according to the present disclosure are described below.

The exemplary embodiments of the present disclosure can provide for methods and systems that can allow users to capture multimedia (e.g., in the form of text, images, audio, video, animation and/or other multimedia), create and publish audience specific data files using this multimedia, and deliver these data files at a time determined by the sender. These data files can be delivered based on various criteria, such as permissions, events, and time, and can be delivered via a secure cloud-based platform. The exemplary embodiments can provide users with the ability to customize a full spectrum of secure file sharing based on the intended audience, from completely private to completely public.

The exemplary embodiments of the present disclosure can provide for a virtual, cloud-based location for providing this multimedia. As a result, the survival rate of such multimedia is significantly increased as they are less likely to be lost or destroyed as compared to physical files (e.g., letters, tapes and/or prints of photos). In addition, such exemplary embodiments reduce the cost associated with preserving such multimedia.

In some exemplary embodiments of the present disclosure, users can capture multi-sensory moments using both web-based and mobile applications to upload any text, images, audio, video, and/or other multimedia to their specific account. Once media assets are uploaded to the account and to their specific platform, users can create a message from, e.g., a blank template using an online editor. The user can also choose customizable “memory filters” to compile and artistically render messages in ways that capture the user's impression of the memory in one click. Any template can be saved and shared at the user's discretion.

Flexibility and ease-of-use can be provided in the various implementations of the exemplary embodiments of the present disclosure. Users can select their audience, for each type of media or combination of media from their personal network, including email contacts and/or other social media connections. The user(s) can provide tiered access and/or condition(s)-based access to the one or more files for any combination of users in their network(s).

Tiered access can allow users to permit full access, limit access or deny access to the available audience in their network. It can also allow users to permit full access or limit access or deny access to selected elements of the file(s) for the intended audience within their network. Conditions-based access can allow users to set conditions for accessing one or more data files. When the conditions are met the date file or element in the file becomes viewable. Conditions can be based on various factors, such as an event(s), time, date, condition or other similar factor, that can trigger the delivery or unlocking of the file and grant access to a recipient.

The files can be delivered based on a specified time lapse, a future date, and/or an event in the future or other predetermined condition. Time lapses can be measured in seconds, minutes, hours, days, and years and can be determined by the user. In some exemplary embodiments, events can trigger the delivery of a file when the criteria of the event are satisfied, that is, when the event occurs. If the event does not occur, conditions can be set such that the file is not delivered to a recipient. For example, a wedding or the birth of a daughter can be the event to trigger the delivery of the file to a recipient.

The exemplary embodiments of the present disclosure allow users to capture and share moments of their life that they want to share with others and/or future generations. Users can organize these moments and information from a central hub and archive them in the form of data files, which can be shared in a “life story” and shared with audiences the user chooses.

In some exemplary embodiments of the present disclosure, these data files containing one or more multimedia (such as text, audio, video and/or pictures), can be stored in a secure, searchable, cloud-based database. Users can select the amount of data storage needed to preserve their files. Users can be provided the ability to save information scattered across multiple social networks in a central, easily accessible location.

Users can login to a website with a unique identifier to the user (e.g., email address, phone number, social network profile, etc.), and there can be an added security feature that can be used via 2-factor authentication. From a home page, people may notate user-representative information and add metadata to organize their data files and determine who may have access to the data files. Users can have a variety of memory filter templates that can facilitate this indexing and organization, such as by providing titles to each data file. For example, a data file can be titled “My Sweet 16”, and can contain one piece of information, such as a picture, or can contain several pieces of information, such as pictures, text, video and/or audio.

During the time the data file is stored on a server, according to an exemplary embodiment of the present disclosure, the user can control and enable whom, when, and where the data can be viewed. The creator of the data files can change these permissions and limit or provide access at any time. Through dedicated recordkeeping, it can be ensured that only the intended recipient(s) will receive the data file(s).

A database can be provided according to an exemplary embodiment of the present disclosure, such as a central repository where storing, locating, and sharing the data files containing various multimedia for each user can be provided. Centralized digital storage can enable scalable collaboration and the sharing of data files with friends, families and others.

In some exemplary embodiments of the present disclosure, more than one user can contribute or provide multimedia to a particular file. For example, more than one user can provide pictures, video, text and/or other multimedia to the particular data file, such as a particular event in the user's life (e.g., wedding, birthday, etc.). This can allow certain family members, friends, vendors or associates to contribute data files to and/or collaborate on a given data file. Users can invite others to follow them, allowing users to follow relevant events in a user's life. A search bar can be provided having a database of everyone in the user's network. Each follower will only have access to the data file(s) the user intends the follower to have.

The exemplary embodiments of the present disclosure allow for the data files to be shared in the present, such as with friends or family, or in the future, such as for future family and future generations if the user desires to do so.

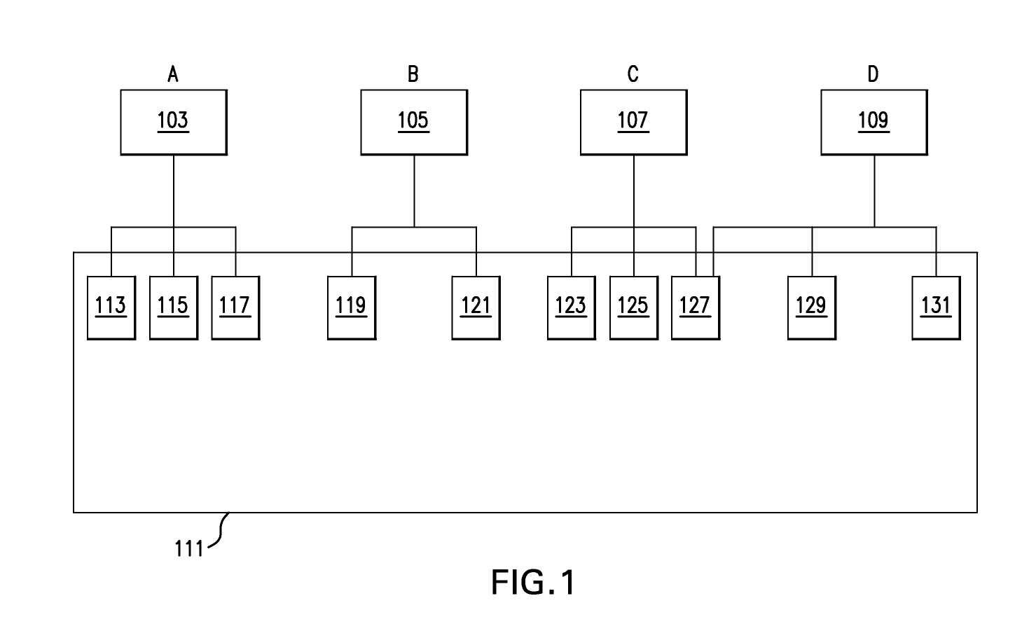

FIG. 1 is an illustration of an exemplary system of the present disclosure. For example, as shown in FIG. 1, there may be a user A, B, C and D. The number of users is not limited to any particular number and the present disclosure contemplates a number of users. The users may use electronic devices 103, 105, 107 and 109. The electronic device can be a personal computer, laptop, notepad, tablet, mobile device, camera, video camera or any other type of electronic device. The user can have various multimedia, such as but not limited to audio, video, images, text and/or other multimedia stored on their electronic device. These multimedia can be uploaded in the form of a data file to server 111. For example, user A can upload data files 113, 115 and 117 to server 111, user B can upload data files 119 and 121 to server 111, user C can upload data files 123, 125 and 127 to server 111, and user D can upload data files 129 and 131 to server 111.

Each data file can include one or more multimedia. For example, data file 113 can include audio and video related to a wedding, data file 115 can include a picture of a birthday, and data file 117 can include pictures and video of holiday gathering for a family. The data files are not limited to any particular media and each data file can contain one or more of any audio, video, images, text and/or other multimedia that can be uploaded to a server 111.

Each data file also includes control access that the particular user who uploads the data file to the server can provide, such that the user can control and provide permission to who can view the data file and when. For example, user A can control data file 113 so that only user B and user C can see the data file 113, and data file 117 can only be seen by user D. In this situation, the server 111 would only allow access to the particular data files to the users set by the user who uploaded the data file. Further, the user can control when the particular recipient will be able to view the data file. For example, user A may control data file 115 such that user B can see it at a certain time, e.g., 30 days. The time can be any number of seconds, hours, days, months or years and is not limited. The user can also modify this time at any point. An immediate notification can be provided to users B and C that user A has shared a data file with them, but is not immediately available. This can build anticipation from users B and C of what was sent to them by user A. The user can also send themselves a data file in the future. For example, user A can send themselves data file 117 in the future, such that when that time comes, server 111 would send the user that particular data file, via email or a request to view that particular data file in their account. Such embodiments can be used for predictions, such as for sporting events, elections, stocks, housing markets, etc.

Optionally, a “teaser” can be sent immediately to recipients if the user plans to send his data file to other users after a certain time period. For example, user B may decide it wants to send data file 119 to users C and D, but not for two days. User B can send a “teaser” immediately to users C and D such that users C and D would anticipate this data file. For example, a title could be sent such as “My Big Bash”, leaving users C and D curious as to what event the data file may contain. If text is included in the data file, the text could be scrambled and provided to the recipients. If a photo is included in the photo could be blurred or some other type of variation of the photo could be provided. If a video is included in the data file, a short clip of the video or a ripple effect on a few frames of the video could be provided to spark curiosity of the recipients.

The data file can also be delivered based on an event that may occur, such as the next presidential election, or the delivery may be conditional, depending on a certain condition or event to occur.

The user can have an account stored in the server so that all data files uploaded are shared with anyone in the user's networks, such that if users B and C are in user A's network, then all data files uploaded by user A can be viewed by users B and C. User A can still control when each data file can be viewed by users in their network. The user A may restrict access to view their data files at any time for any recipient. Therefore, each user can have a particular number of contacts in their network, and can have more than one network. For example, user A can have users B in their personal network, such as family or friends, and have user D in the professional network, such as a business partner. Therefore, user A can restrict each data file as to which is to be viewed by their personal or professional networks.

The user can also be an entity or group, and not a person. For example, user D can be a group, such as a political party, fraternity, high school friends, company or other group, and is not limited to any particular person or number of people, or type of entity.

The exemplary embodiments of the present disclosure provide for collaboration with other websites and/or social networks. For example, a user can choose multi-media from other websites in order to not only capture the multimedia, but also the particular contact with who that multimedia is associated, and the time period. For example, a user can upload pictures and video from other websites to the server, and create a data file from that multimedia, for sharing with other users immediately or at another time. The contacts associated with the multimedia can also be included such that such information is captured in the particular data file, e.g., a person in a particular picture with the user.

A user can view all their data files stored in a server based on a particular contact, a group or a date. For example, the user can select data files according to a date, allowing them to see all data files associated with a particular date or time frame, creating a way to remember the particular date or time frame for the user, which can assemble all multimedia uploaded to the server along with any multimedia from other social websites.

In some exemplary embodiments of the present disclosure, a user can upload all pictures, audio recordings, videos, texts and/or other multimedia to the user's account in the server 111. The user can create data files at a later time, and choose which multimedia can be attached to which data file, and choose any contacts associated with that multimedia. Any of these data files can be chosen to share with any recipient in the present or in the future.

In some exemplary embodiments of the present disclosure, a data file can be created between more than one person, so that users can share it on their network. Multiple users can add to that data file, so that the data file is shared between users in their network, allowing more than one user to add to or modify the data file. For example, user C can upload data file 127 using electronic device 107 to the server 111, which can be related to a particular event, e.g., a wedding. User C can choose to allow user D to also be a creator of the data file 127, such that user D can also have access to data file 127, and can add pictures, video, text or other multimedia to data file 127. Therefore, user C and user D can control who can view the data file 127 and can control when any particular recipient would have access or be provided permission to that particular data file.

In some exemplary embodiments of the present disclosure, users can follow other user's and follow the data files and life stories of other users. The users also may follow celebrities, public figures and groups (who can choose which data files to share with which users, such as some for “all”). This can allow some users to see data files of people or groups they may be interested in, and allow celebrities, public figures, groups, etc. to share their data files with the world. The data files can have adjustable levels of privacy. For example, if user B was a celebrity such as a movie star, and data file 119 was related to a shooting of a movie, if users C and D followed user B, and user B were to provide control access to data file 119 to be allowed to be viewed by their followers at a predetermined time, then users C and D would be able to view data file 119. For example, this can be beneficial if the trailer of the movie was to be released by 2 pm on a particular date, user B could provide access to the data file 119 an hour prior to that. The control for that could be provided ahead of time, such as a month ahead of time, so that the permission for viewing the data file 119 would automatically be provided at that time by server 111.

This can be different than if users were in each other's network. For example, if data file 121 was personal to user B, then control access could be provided so that users C and D would not be able to view data file 121, even if users C and D followed user B. Only user A may be able to see data file 121 if user A is in user B's network, such as a family member or friend. Providing control of the recipients of the data files and when the particular data file can be viewed can be important to many people or entities.

In some exemplary embodiments of the present disclosure, pages of events relating to a person or entity can be provided. For example, digital pages can be provided (for viewing through an electronic device) in which each page associated with a user can include a different moment captured with various multimedia. Each user can have any number of pages as the user creates, and can have a new page for every day, hour, week, month, year or whatever time frame the user chooses. The pages can be filled with a moment the user captures in video, picture, letters, recordings, and/or contacts associated with the multimedia. The contact can be associated when, e.g., a picture or video has that contact in it or by the user connecting a contact with the particular multimedia (e.g., by “tagging” the multimedia with that contact).

In some exemplary embodiments of the present disclosure, the date and place of when and where the user is can be on a top of the page. Each page can be unique in its material. Some can include only text, or pictures, or video, or a combination of all. The pages can allow for navigation of the pages based on date, showing the various data files according to dates. A graphic illustration can be provided causing the digital pages to have the look and feel of an actual book with pages.

A page can be provided where users can submit a new page to add to the digital book, allowing them to add data files and contacts associated with the data files to the particular page. For example, a new page can be added by a user for a particular event (birthday, marriage, etc.). A page can also be provided for users to send themselves data files into the future. For example, a user can send themselves a data file with writing, pictures, videos, voice recordings, and contacts, and/or other multimedia into the future by a day, week, month, year, etc.

The exemplary embodiments of the present disclosure can be provided using a personal computer, laptop, notepad, mobile device or any other type of electronic device. In some exemplary embodiments, a mobile phone can be provided having an application that provides the features described in the present disclosure as will be explained below.

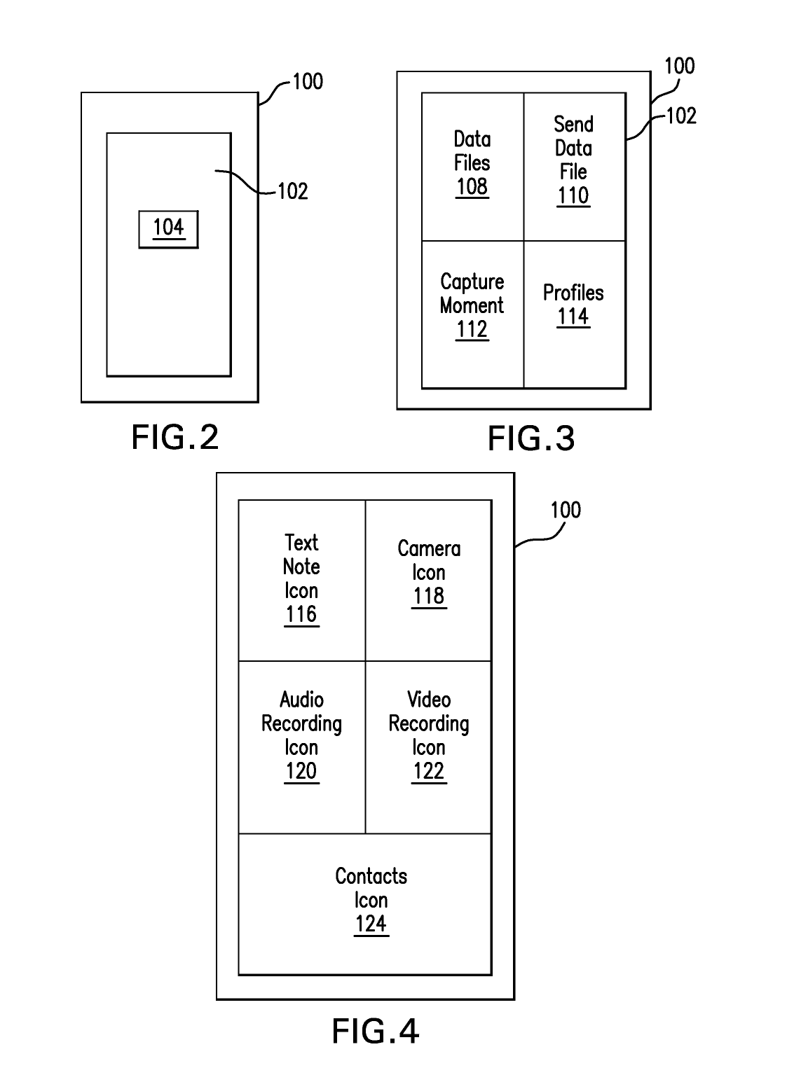

Users will be able to send data files containing text, pictures, videos, recordings and/or other multimedia to themselves, friends, family and other generations in the future from their mobile device using a phone application. For example, as shown in FIG. 2, a mobile device 100 can be provided having a screen 102 that can display a logo 104. Tapping on the logo can provide the screen shown in FIG. 3, which can give a user various options or icons, e.g., “Data Files” icon 108, “Send Data File” icon 110, “Capture Moment” icon 112 and “Profiles” icon 114.

Clicking on a “Capture Moment” icon 112 can provide the screen in FIG. 4, where the user can choose to capture the moment utilizing all forms of media, such as entering text through a “Text Note” icon 116, taking a picture using a “Camera” icon 118, recording sound using an “Audio Recording” icon 120, or taking a video using “Video Recording” icon 122. There can also be a “Contact” icon 124 to select people from their contact lists to choose a contact by their name or picture. The icons can be changed or added/deleted according to the user's preference, and other icons for other multimedia can also be included.

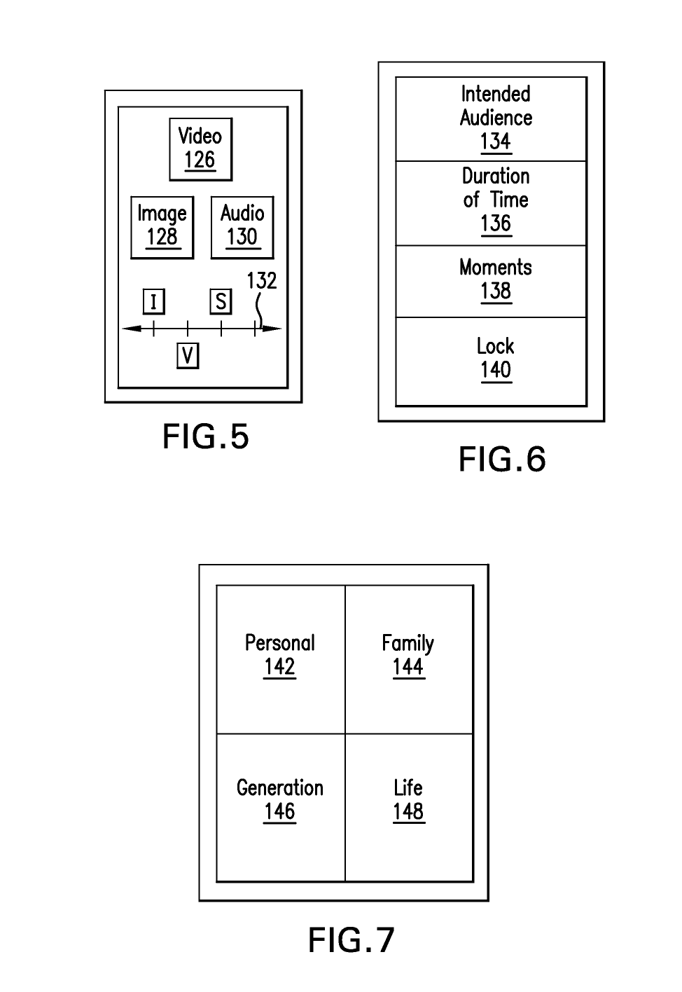

Clicking on the “Data Files” icon 108 can provide a screen as shown in FIG. 5, where a user can view all the multimedia uploaded or added in the user's account. The user can view all of their content, such as any video(s) 126, image(s) 128 and audio 130. A timeline 132 can also be provided (along with dates) showing various multimedia associated with the user according to the date posted (e.g., image I, sound S, video V), where scrolling to the left can take you backwards in time and scrolling forward can take you forward in time. Here, any content uploaded to the user's account can be viewed on the screen. When a user captures any moment or sends any data file to the server, that particular data file will be added or saved to the user's account.

By clicking on the “Send Data File” icon 110, it can allow a user to send a data file from their mobile device 100, as shown in FIG. 6. A user can choose their intended audience 134, allowing the user to select who to share the data file with. The user can select the duration of time 136, allowing the user to select a date/time to allow when the data file can be shared. The user can choose the moment 138 they want to use as the data file, such as text, audio or video stored in their mobile device, or captured at that instant. The user can then send the data file to the intended recipient(s). The user can be provided an option of locking the data file using a lock icon 140, which can, e.g., provide a security code for the data file in order for the recipient to open the data file.

By clicking on the “Profiles” icon 114, the screen as seen in FIG. 7 can be provided, illustrating a Personal icon 142, Family icon 144, Generation icon 146 and Life icon 148. The user can choose which contacts are displayed under the icons, and can change the names and categories of the various icons. For example, the user can choose contacts under family, friends, business associates, schools, fraternities, sororities, professional networks, etc. Choosing a particular contact will show all the shared data files with the particular contact.

In some exemplary embodiments of the present disclosure, a GPS can be provided on the mobile device or other electronic device. This can allow a company such as a merchandise store, to monitor if a potential customer may be within the vicinity. Any user of the exemplary embodiments of the present disclosure can be a potential customer. For example, a merchandise store can send a data file containing coupons or special offers, which may or may not be time limited. This can be location specific so that the user only received such data files if they are within a predetermined distance from the particular merchandise store. This can also be used if, e.g., a user is attending an event (e.g., sporting event, concert, tournament, etc.) in a specific geographic area. If the user is at such an event, e.g., a sporting event, a team can send content or discounts at a team store, giveaways, special offers, or other information which the user may want to receive from the particular team.

The exemplary embodiments of the present disclosure can allow for members of a family to share their data files, including text (e.g., letters), audio (e.g., messages to future generations), video or pictures to their future generations or current family members. For example, a video can be made of a family member who moved to a new area or country and wants to make a video of why he/she moved and settled in a new area, where future generations may live. A network of all family members could be made so that all data files can be shared across the network of family members currently and in the future. Permissions and control could be provided so that only members of that family network would be able to view those particular data files. This can also apply not to just family members, but to companies and all their employees, or a group/society and all its members. Restricting permissions and when the particular data file can be seen can be highly important. For example, a user may not want anyone to see a particular message or data file until after a certain time. Presidents or global leaders could provide powerful messages years after their death.

The controls can also be modified so that all data files are only available at a certain time period, e.g., ten years after they are uploaded. The access can be controlled so that the recipient only has permission for a certain time period to view them. For example, a data file can be controlled so that a recipient can view the data file in one year, but only for six months. Various different implementations and modifications regarding the permissions of the data files are provided by the exemplary embodiments of the present disclosure.

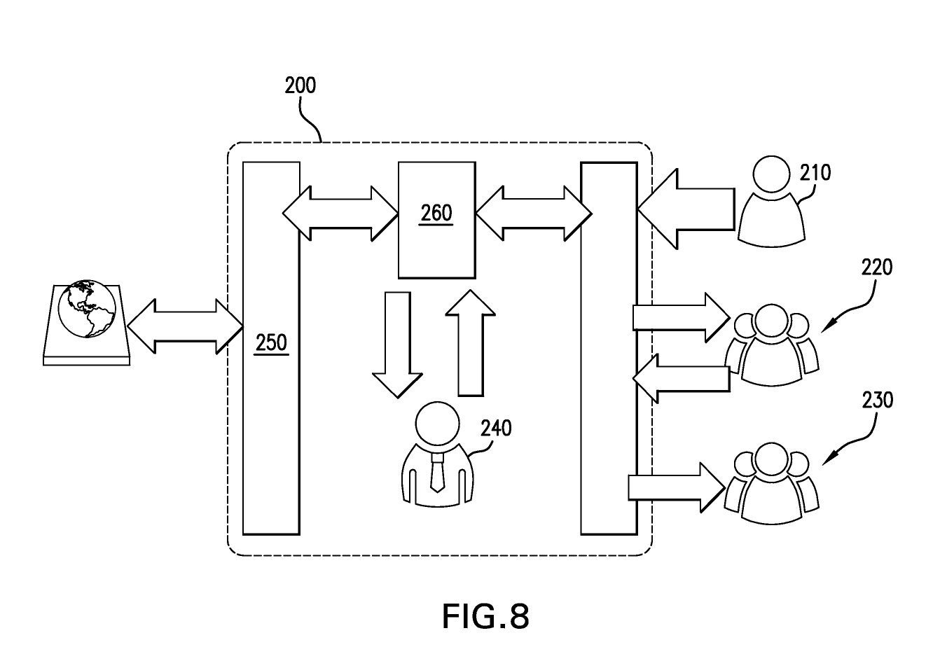

In some exemplary embodiments of the present disclosure, a trustee service can be set up utilizing the teachings of the present disclosure. FIG. 8 is a block diagram of a trustee service 200 according to an exemplary embodiment of the present disclosure. Initially, a sender 210 (e.g., a person(s) who creates and wants to send a message) can use the trustee service 100 or a third party system supported by the Application Programming Interface (“API”) 250 to create a message. A message can be any electronic message to be delivered in the future, which can be digital, audio, video, text, or an electronic document of any format. The API can be used to serve the trustee service to third party messaging platforms such as email, Facebook®, Twitter® and the like.

The sender 210 can include various information in his/her application (i.e., a request application for sending a message to a recipient(s) according to certain terms), such as the definition of the recipient(s) 230, contact information of the related parties 220, estimated delivery date (not mandatory), and a definitions of terms. The delivery date can be the date and time in the future in which the message is to be delivered to the recipient. The creation date can be a date the sender submitted the message. A recipient can be a future recipient of the message. The terms can be a set of logical conditions that need to be resolved to create a triggering event that can trigger the delivery of the message to the recipient(s). The triggering event can be any future event in which the terms are resolved. The related parties can be addressable entities, people or organizations, which are likely be the leads for contacting the recipient and for confirming the terms and the triggering event.

Upon submitting the application, the application may get queued in a CRM system 260, and can be pending review by an agent 240. The agent 240 can be a person who works for a trustee service performing the tasks that may require human discretion such as auditing, due diligence and research. The CRM system 260 can be a client relationship management system, which can be a software component that supports the agent(s) by programmatically notifying them when to conduct various tasks related to the successful delivery of the message such as, e.g., contacting the sender, related parties, recipient, checking and researching data relevant to the terms, scheduling the triggering event and so forth.

The agent 240 can check the feasibility of a delivering of the message within a reasonable effort and budget, and reviews the application. If the agent 240 determines that delivering of the message under the terms is either not feasible or not cost effective, they can reject and application and notify the sender 210, or provide the sender 210 with notice of a revised budget. If the Agent 240 deems that the message is deliverable, the agent 240 can estimate its cost by considering various factors such as estimated delivery time, complexity, availability of the related parties 220 and so forth. The agent 240 can then charge the sender 110 accordingly.

Periodically and according to the particular terms, the CRM 260 can perform checks to assess the progress of the terms being resolved. In particular, the CRM 260 can send automated emails to the sender 210 and related parties 220, inquiring about their status, and/or send reminders to the agent(s) 240, advising them to review the status of the terms and use human discretion where relevant.

Once the addressable recipient(s) 230 has been identified and confirmed by an agent 240, their contact information can be logged. Once the triggering event has been identified and confirmed by an agent 140, it can be logged. Once the terms have been resolved and confirmed by an agent 240, a delivery date can be chosen and confirmed by an agent 240. On the delivery date, the message can then be sent to the recipient(s) 230.

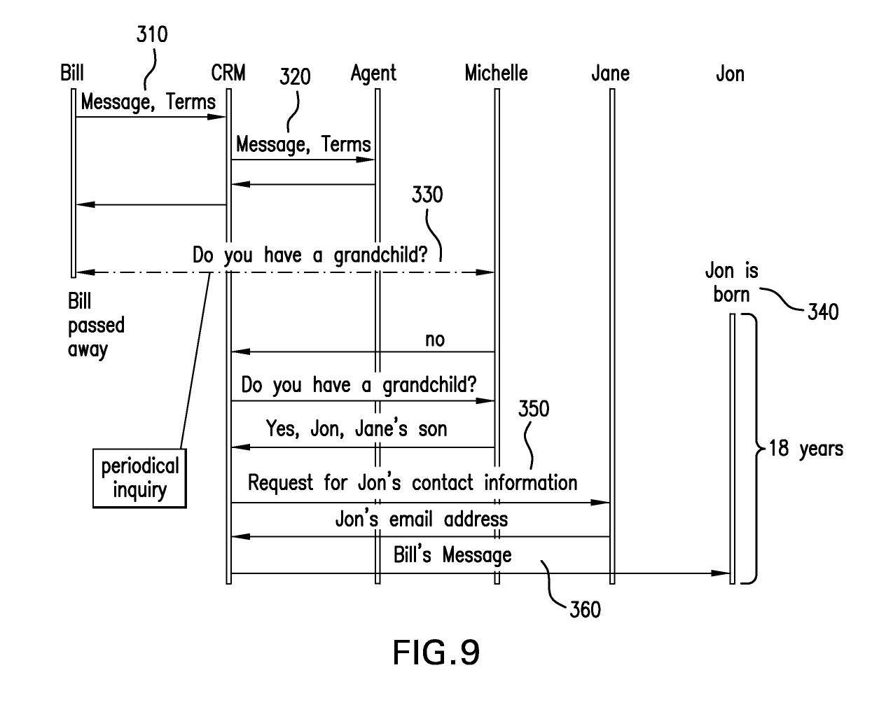

FIG. 9 is an illustration of an example in which the trustee service of FIG. 8 can be utilized according to an exemplary embodiment of the present disclosure. In the example shown in FIG. 9, the sender can be Bill, father to Jane and Matt. The recipient can be Bill's first grandson. The terms can be that Bill's first grandson is older than 18. The triggering event can be Bill's first grandchild's 18^{th} birthday party, and the related parties can be Bill's wife Michelle, and Jane and Matt (Bill's children).

In this example, Bill can first set up the message and terms at 310, and the Message and terms can be provided to an agent at 320, and a quote of a charge can be provided to Bill and approved by Bill. In the future, Bill may pass away, in which case the related parties are contacted by the agent and/or the CRM. At 330, for example, Michelle can be contacted at periodical inquiries to inquire if she has a grandchild. At some point in the future, a grandchild Jon may be born at 340. Note that Michelle may pass away as well, in which Bill's children will be contacted. The related parties may change as time passes, and there may be an order of succession of whom to contact set up by the sender.

Once Jon is born, a request may be made at 350 for Jon's contact information, including an email address. As this information may change over time, periodical inquiries may be made as to the status of the email account, and email verification may be required. Once Jon is 18 years of age, the Message is provided from Bill to Jon at 360.

Various other considerations can also be addressed in the exemplary applications described according to the exemplary embodiments of the present disclosure. Different terms and various forms of messages may be delivered. The trustee service can have various agents for various assignments, and some may involve human intervention and some may not. For example, an event such as a particular date may be picked up by the computer and may not require human intervention. Various events can be provided in the terms for delivery of the message to the recipients.

The exemplary embodiments of the trustee service of the present disclosure can be used in various configurations and in different systems. Various computing arrangements can be provided, having a processor(s) configured or programmed to perform the exemplary steps and/or procedures of the exemplary embodiments of the present disclosure described above. Various data described above can be stored in various storage arrangements (e.g., hard drive, memory device, such as RAM, ROM, memory stick, floppy drive, other tangible computer-accessible medium, etc.). The processor(s) can access the storage arrangement(s) to execute a computer program or a set of instructions (stored on or in the storage arrangement) which can perform the procedures according to the exemplary embodiments of the methods and systems of the present disclosure.

The innovations herein may be implemented via one or more components, systems, servers, appliances, other subcomponents, or distributed between such elements. When implemented as a system, such system may comprise, inter alia, components such as software modules, general-purpose CPU, RAM, etc. found in general-purpose computers, and/or FPGAs and/or ASICs found in more specialized computing devices. In implementations where the innovations reside on a server, such a server may include or involve components such as CPU, RAM, etc., such as those found in general-purpose computers.

Additionally, the innovations herein may be achieved via implementations with disparate or entirely different software, hardware and/or firmware components, beyond that set forth above. With regard to such other components (e.g., software, processing components, etc.) and/or computer-readable media associated with or embodying the present inventions, for example, aspects of the innovations herein may be implemented consistent with numerous general purpose or special purpose computing systems or configurations. Various exemplary computing systems, environments, and/or configurations that may be suitable for use with the innovations herein may include, but are not limited to: software or other components within or embodied on personal computers, servers or server computing devices such as routing/connectivity components, hand-held or laptop devices, multiprocessor systems, microprocessor-based systems, set top boxes, consumer electronic devices, network PCs, other existing computer platforms, distributed computing environments that include one or more of the above systems or devices, etc.

In some instances, aspects of the innovations herein may be achieved via or performed by logic and/or logic instructions including program modules, executed in association with such components or circuitry, for example. In general, program modules may include routines, programs, objects, components, data structures, etc., that perform particular tasks or implement particular instructions herein. The innovations may also be practiced in the context of distributed software, computer, or circuit settings where circuitry is connected via communication buses, circuitry or links. In distributed settings, control/instructions may occur from both local and remote computer storage media including memory storage devices.

Innovative software, circuitry and components herein may also include and/or utilize one or more type of computer readable media. Computer readable media can be any available media that is resident on, associable with, or can be accessed by such circuits and/or computing components. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic tape, magnetic disk storage or other magnetic storage devices, or any other medium which can be used to store the desired information and can accessed by computing component. Communication media may comprise computer readable instructions, data structures, program modules or other data embodying the functionality herein. Further, communication media may include wired media such as a wired network or direct-wired connection, and wireless media such as acoustic, RF, infrared and other wireless media. Combinations of the any of the above are also included within the scope of computer readable media.

In the present description, the terms component, module, device, etc. may refer to any type of logical or functional software elements, circuits, blocks and/or processes that may be implemented in a variety of ways. For example, the functions of various circuits and/or blocks can be combined with one another into any other number of modules. Each module may even be implemented as a software program stored on a tangible memory (e.g., random access memory, read only memory, CD-ROM memory, hard disk drive, etc.) to be read by a central processing unit to implement the functions of the innovations herein. Or, the modules can comprise programming instructions transmitted to a general purpose computer or to processing/graphics hardware via a transmission carrier wave. Also, the modules can be implemented as hardware logic circuitry implementing the functions encompassed by the innovations herein. The modules can be implemented using special purpose instructions (SIMD instructions), field programmable logic arrays or any mix thereof which provides the desired level performance and cost.

As disclosed herein, features consistent with the present disclosure may be implemented via computer-hardware, software and/or firmware. For example, the systems and methods disclosed herein may be embodied in various forms including, for example, a data processor, such as a computer that also includes a database, digital electronic circuitry, firmware, software, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the invention or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the invention, or it may be more convenient to construct a specialized apparatus or system to perform the required methods and techniques.

Aspects of the method and system described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, manufacture and methods which, although not explicitly shown or described herein, embody the principles of the disclosure and are thus within the spirit and scope of the disclosure. The disclosures of all documents and publications cited herein are hereby incorporated herein by reference in their entireties.

What is claimed is:

1. A method for providing multimedia, comprising:
receiving one or more data files containing multimedia from a first user;
storing the one or more data files containing the multimedia; and
providing at least one of the one or more data files based on access granted by the first user and at a future time set by the first user.

2. The method according to claim 1, wherein the multimedia comprises one or more of image(s), audio, text, animation and video.

3. The method according to claim 1, wherein the first user and at least one other user provide multimedia to at least one of the one or more data files.

4. The method according to claim 1, further comprising:
providing the at least one of the one or more data files to one or more users; and
providing notification to the one or more users that the at least one of the one or more data files shall be provided by the first user before providing the at least one of the one or more data files to the one or more users.

5. The method according to claim 1, wherein the at least one of the one or more data files are provided in a chronological order.

6. The method according to claim 1, wherein the one or more data files is received from an electronic device including one or more of a mobile device, laptop, notepad, tablet or personal computer.

7. A computer-accessible medium which contains thereon software for providing multimedia, wherein, when a processing arrangement executes the software, the processing arrangement is configured to perform procedures comprising:
receiving one or more data files containing multimedia from a first user;
storing the one or more data files containing the multimedia; and
providing at least one of the one or more data files based on access granted by the first user and at a future time set by the first user.

8. The computer-accessible medium according to claim 7, wherein the multimedia comprises one or more of image(s), audio, text, animation and video.

9. The computer-accessible medium according to claim 7, wherein the processing arrangement is further configured to perform procedures comprising:
providing the at least one of the one or more data files to one or more users; and
providing notification to the one or more users that the at least one of the one or more data files shall be provided by the first user before providing the at least one of the one or more data files to the one or more users.

10. A system for providing multimedia, comprising:
a database of accounts for each of a plurality of users;
a storage system for storing data files containing multimedia associated with the accounts for each of the plurality of users, including:
i. first instructions from each of the plurality of users specifying a set of user(s) that the data files associated with their respective accounts are to be provided to, and
ii. second instructions specifying when the set of user(s) are to be provided the data files associated with their respective accounts; and
a processing arrangement configured to provide the data files to the specified set of user(s) based on the first and second instructions.

11. The system according to claim 10, wherein the processing arrangement is further configured to:
provide notification to the specified set of user(s) that the data files shall be provided before providing the data files to the specified set of user(s) based on the first and second instructions.

12. The system according to claim 10, wherein the multimedia comprises one or more of image(s), audio, text, animation and video.

13. The system according to claim 10, wherein each data file contains multimedia from more than one of the plurality of users.

14. The system according to claim 10, wherein the data files are provided in a chronological order.

15. The system according to claim 10, wherein the one or more data files containing multimedia are received from each of the plurality of users from an electronic device including one or more of a mobile device, laptop, notepad, tablet or personal computer.

16. A method of providing a trustee service for providing multimedia, comprising:
receiving one or more data files containing multimedia from a first user;
storing the one or more data files containing the multimedia;
receiving information from the first user specifying one or more people with whom at least one of the one or more data files should be provided to based on a predetermined criteria;
monitoring if the predetermined criteria has been met over a period of time; and
providing the at least one of the one or more data files to the one or more people specified by the first user when the predetermined criteria has been met.

17. The method of claim 16, wherein the multimedia comprises one or more of image(s), audio, text, animation and video.

18. The method of claim 16, wherein the predetermined criteria comprises one or more of a date, a condition and a future event.

19. The method according to claim 16, further comprising:
providing notification to the one or more people specified by the first user that the at least one of the one or more data files shall be provided by the first user before providing the at least one of the one or more data files to the one or more people specified by the first user.

20. The method according to claim 16, wherein the at least one of the one or more data files is provided electronically to the one or more people specified by the first user.
